(19) United States
(12) Patent Application Publication
(10) Pub. No.: US 2025/0153646 A1
(43) Pub. Date: May 15, 2025

(54) EXTENDABLE TRUCK BED

(71) Applicant: JUAN RODRIGUEZ, ZEPHYR HILLS, FL (US)

(72) Inventor: JUAN RODRIGUEZ, ZEPHYR HILLS, FL (US)

(21) Appl. No.: 18/388,805

(22) Filed: Nov. 10, 2023

(51) Int. Cl. B60R 5/04; B62D 33/027

(52) U.S. Cl. CPC B60R 5/041; B62D 33/027

(57) ABSTRACT

An extendable truck bed that includes a first side panel, wherein the first side panel includes a telescoping side panel. The telescoping side panel extends vertically from the first side panel. The extendable truck bed also includes a second side panel, wherein the second side panel includes a telescoping side panel. Likewise, the second telescoping side panel extends vertically from the second side panel. The extendable truck bed also includes a telescoping extension within the bed, where said telescoping extension works in conjunction with the telescoping side panels.

### BACKGROUND OF THE INVENTION

### Field of the Invention

The present invention relates to an extendable truck bed with telescoping side panels and truck bed.

### Description of Related Art

The typical pick-up utility truck includes a cabin area for driver and passenger seating and a cargo bed for transporting cargo or tools. On occasion the user of such a pick up truck and may need additional storage area for certain types of equipment or materials. Consequently, it would be advantageous to have a means to expand the cargo area at will.

The ability to modify the cargo area may be difficult to accomplish with a typical aftermarket truck bed extension. Further such modification may be cost prohibitive or impossible to implement. Therefore, it would be advantageous to have a cargo bed that is easily extendable and enables the user to expand the cargo area at will.

Examples of cargo bed extensions are well-known in the prior art. However there have been some limitations with respect to the implementation of cargo bed extensions. Some cargo extensions are difficult to extend and retract as needed and others simply cannot provide the adequate support of the extended bed. These are problems are addressed with the present invention as set forth below.

### SUMMARY OF THE INVENTION

The present invention relates to an extendable truck bed that includes a first side panel, wherein the first side panel includes a telescoping side panel. The telescoping side panel extends vertically from the first side panel. The extendable truck bed also includes a second side panel, wherein the second side panel includes a telescoping side panel. Likewise, the second telescoping side panel extends vertically from the second side panel. The extendable truck bed also includes a telescoping extension within the bed, where said telescoping extension works in conjunction with the telescoping side panels.

Further features of the present invention include a tail gate and an underside support frame. The underside support frame supports an underside of the truck bed. So as the truck bed extends for lengthening purposes the underside support reinforces and supports the frame. The truck bed provides the user with a convenient and effective means to lengthen the truck bed as desired.

In view of the foregoing disadvantages inherent in the prior art, the general purpose of the present invention is to provide a pillowcase assisting tool to position a pillow within a pillowcase, configured to include all of the advantages of the prior art, and to overcome the drawbacks inherent therein.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 shows a perspective view of a truck bed according to the present invention.

FIG. 2 shows a perspective view of the truck bed wherein the bed is extended.

FIG. 3 shows an underside of the truck bed.

FIG. 4 shows a top view of the truck bed.

### DETAILED DESCRIPTION OF THE DRAWINGS

The present invention relates to an extendable truck bed that allows a user to gain additional length of the bed as needed. The truck bed according to the present invention includes telescoping side panels that extend from an extension sleeve. Further the truck bed has a telescoping bed surface of that joins with the telescoping panels to provide an extension area for the user. Once the extended bed is at a desired position, the extended bed locks securely and provides usage as desired. Conveniently the bed may be close to a shorter and stationary position when the extended position is not necessary.

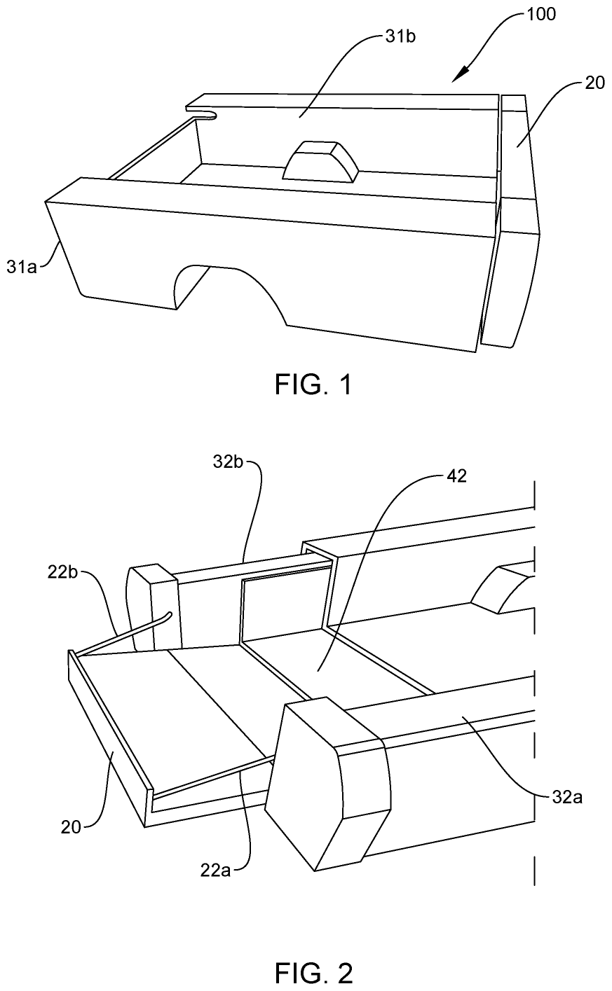

FIG. 1 shows a perspective view of a truck bed 100 according to the present invention. The truck bed 100 includes a first side panel 31a and second side panel 31b. Further a tailgate 20 is shown. The tailgate 20 may include a closed position and an open or lower position. FIG. 2 shows the tailgate 20 in the lower position. Also shown in FIG. 2 is the extendable or telescoping bed 42. Working in conjunction with the telescoping bed 42 are telescoping side panels 32a, 32b. The telescoping side panels 32a, 32b allow for the extension of the truck bed 100. Gate supports 22a, 22b support the tailgate 20 in the lowered position as shown.

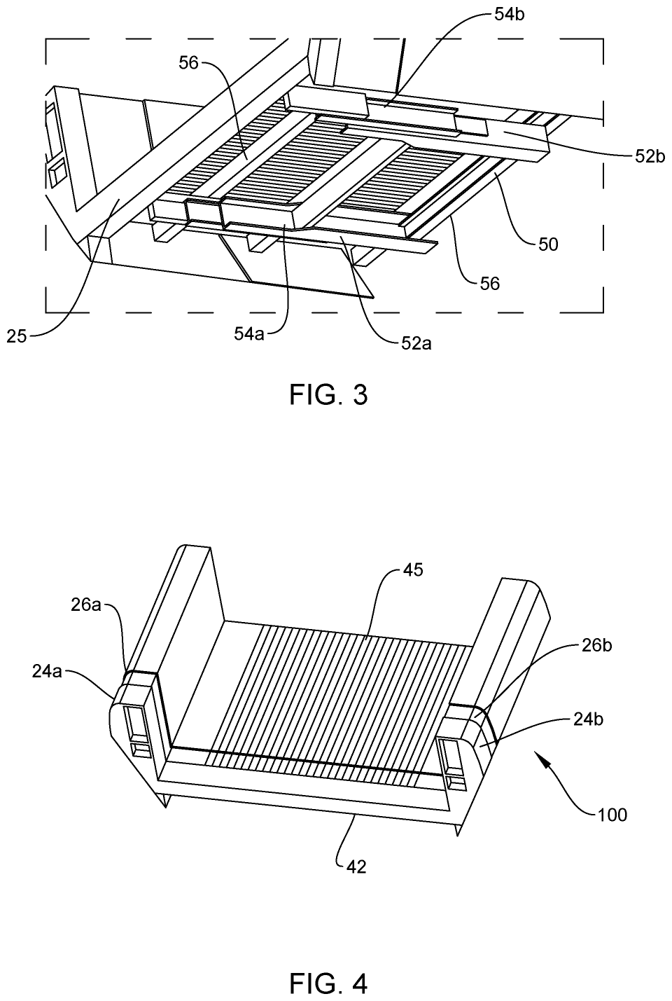

The truck bed 100 is further supported by an underside frame 50 that is shown in FIG. 3. The underside frame 50 includes a side support 52a and a side support 52b. Within the side supports 52a, 52b are telescoping extensions 54a, 54b. The telescoping extensions 54a, 54b adjoin to the underside of the telescoping bed 42. Further, a cross support 56 extends between the side supports 52a, 52b.

As additional view of the truck bed 100, FIG. 4 shows truck bed 45 with a slight extension of the telescoping side panels 32a, 32b. The slight extension of FIG. 4 shows each telescoping extension sleeve 26a, 26b. The telescoping extension sleeves 26a, 26b contain and each telescoping side panel 32a, 32b respectively. Tail gate frame 24a, 24b is also shown on each respective side of the telescoping bed 42. Overall, the truck bed 100 device is convenient and effective mechanism to a lengthen the size of truck bed on a as needed basis.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An extendable truck bed comprising:
a. a first side panel, wherein the first side panel includes a telescoping side panel, wherein said telescoping side panel extends vertically from the first side panel;
b. a second side panel, wherein the second side panel includes a telescoping side panel, wherein said telescoping side panel extends vertically from the second side panel;
c. a truck bed, wherein the truck bed includes a telescoping extension, where said telescoping extension works in conjunction with the telescoping side panels;
d. a tail gate; and
e. an underside support frame, supporting an underside of the truck bed.

2. The extendable truck bed according to claim 1, further including gate supports, where the gate supports support the tailgate in a lowered position.

3. The extendable truck bed according to claim 1 according to claim 1, where the underside support frame includes a first side support and a second side support.

4. The extendable truck bed according to claim 3, where the first side support and the second side support, each include a telescoping extension wherein each said telescoping extension adjoin to the underside of the truck bed.

5. The extendable truck bed according to claim 1, further including a telescoping extension sleeve for each telescoping side panel.
